(19) United States
(12) Patent Application Publication
(10) Pub. No.: US 2018/0232810 A1
(43) Pub. Date: Aug. 16, 2018

(54) PORTFOLIO OPTIMIZATION USING THE DIVERSIFIED EFFICIENT FRONTIER

(71) Applicant: PROVINZIAL RHEINLAND VERSICHERUNG AG, Düsseldorf (DE)

(72) Inventor: THOMAS HEINZE, Düsseldorf (DE)

(73) Assignee: PROVINZIAL RHEINLAND VERSICHERUNG AG, Düsseldorf (DE)

(21) Appl. No.: 15/431,199

(22) Filed: Feb. 13, 2017

(51) Int. Cl. G06Q 40/06

(52) U.S. Cl. CPC G06Q 40/06

(57) ABSTRACT

The invention relates to a computer-implemented method for selecting a value of portfolio weight for each of a plurality of assets of a portfolio, each asset having a defined expected return and a defined standard deviation of return, each asset having a covariance with respect to each of every other asset of the plurality of assets, the method may comprise the following steps:
a. creating a mean-risk portfolio optimization model/problem to compute the mean-risk efficient frontier based at least on input data characterizing the defined expected return and the defined standard deviation of return of each of the plurality of assets;
b. adding a diversification function to the mean-risk portfolio optimization model/problem;
c. computing the diversified efficient frontier; and
d. selecting a portfolio weight for each asset from the diversified efficient frontier.

### TECHNICAL FIELD

The present invention relates to a method for selecting a portfolio of tangible or intangible assets subject to optimization criteria yielding a mean-risk-diversification efficiency.

### BACKGROUND OF THE INVENTION

Managers of assets, such as portfolios of stocks, projects in a firm, or other assets, typically seek to maximize the expected or average return on an overall investment of funds for a given level of risk as defined, for example, in terms of variance of return, either historically or as adjusted using techniques known to persons skilled in portfolio management. Alternatively, investment goals may be directed toward residual return with respect to a benchmark as a function of residual return variance. Consequently, the terms “return” and “variance,” as used in this description and in any appended claims, may encompass, equally, the residual components as understood in the art. The capital asset pricing model of Sharpe and Lintner and the arbitrage pricing theory of Ross are examples of asset evaluation theories used in computing residual returns in the field of equity pricing. Alternatively, the goal of a portfolio management strategy may be cast as the minimization of risk for a given level of expected return.

It is referred to the following prior art:
Black, F., and R. Littermann. 1992. “Global Portfolio Optimization.” Financial Analysts Journal, vol. 48, no. 5 (September/October): 28-43.
Green, R., and B. Hollifield. 1992. “When Will Mean-Variance Efficient Portfolios Be Well Diversified?” Journal of Finance, vol. 47, no. 5 (December): 1785-1809.
Michaud, R. 1989. “The Markowitz Optimization Enigma: Is Optimized Optimal.” Financial Analysts Journal, vol. 45, no 1 (January/February): 31-42.
Sharpe, W. 1994. “The Sharpe Ratio” Journal of Portfolio Management, vol. 21, no 1: 39-47.
Frahm, G., and c. Wiechers. 2013. “A Diversification Measure for Portfolio of Risky Assets”. Palgrave Macmillan: 312-330.

The risk assigned to a portfolio is typically expressed in terms of its variance σ_{P}² stated in terms of the weighted variances of the individual assets, as:

σ_{P}²=ΣᵢΣⱼwᵢwⱼσᵢⱼ (1)

where wᵢ is the relative weight of the i-th asset within the portfolio,

σᵢⱼ=σᵢσⱼρᵢⱼ (2)

is the covariance of the i-th and j-th assets, ρᵢⱼ is their correlation, and σᵢ is the standard deviation of the i-th asset. The portfolio standard deviation is the square root of the variance of the portfolio. The variance σ_{P}² is just one example for a risk measure v.

Following the classical paradigm due to Markowitz, a portfolio may be optimized, with the goal of deriving the peak average return for a given level of risk and any specified set of constraints, in order to derive a so-called “mean-variance (MV) efficient” portfolio using known techniques of linear or quadratic programming as appropriate. Techniques for incorporating multiperiod investment horizons are also known in the art. As shown in FIG. 1, the expected return μ for a portfolio may be plotted versus the portfolio standard deviation σ, with the locus of MV efficient portfolios as a function of portfolio standard deviation referred to as the “MV efficient frontier”. Mathematical algorithms for deriving the MV efficient frontier are known in the art. Each portfolio of the MV efficient frontier can, for example, be computed by solving the maximization problem:

max{αμ(w)−βσ_{P}²(w)|w∈X} (3)

with given α,β≥0, where X is the set of all portfolios fulfilling all specified set of constraints. With an arbitrary risk measure v the maximization problem (3) can be generalized by

max{αμ(w)−βv(w)|w∈X} (4)

Known deficiencies of MV optimization as a practical tool for investment management include the instability and ambiguity of solutions. It is known that MV optimization may give rise to solutions which are both unstable with respect to small changes (within the uncertainties of the input parameters) and often non-intuitive and thus of little investment sense or value for investment purposes. These deficiencies are known to arise due to the propensity of MV optimization as “estimation-error maximizers,” as discussed in R. Michaud, “The Markowitz Optimization Enigma: Is Optimized Optimal?” Financial Analysts Journal (1989), which is herein incorporated by reference. In particular, MV optimization tends to overweight those assets having large statistical estimation errors associated with large estimated returns, small variances, and negative correlations, often resulting in poor ex-post performance.

### SUMMARY OF THE INVENTION

In accordance with one aspect of the invention, in one of its embodiments, there is provided a method for evaluating an existing or putative portfolio having a plurality of assets. The existing portfolio is of the kind having a total portfolio value, where each asset has a value forming a fraction of the total portfolio value, each asset has a defined expected return and a defined standard deviation of return, and each asset has a covariance with respect to each of every other asset of the plurality of assets.

According to the invention, a computer-implemented method for selecting a value of portfolio weight for each of a plurality of assets of a portfolio is provided, each asset having a defined expected return and a defined standard deviation of return, each asset having a covariance with respect to each of every other asset of the plurality of assets. The method according to the invention comprises the following steps:
a. creating a mean-risk portfolio optimization model/problem to compute the mean-risk efficient frontier based at least on input data characterizing the defined expected return and the defined standard deviation of return of each of the plurality of assets;
b. adding a diversification function to the mean-risk portfolio optimization model/problem;
c. computing the diversified efficient frontier; and
d. selecting a portfolio weight for each asset from the diversified efficient frontier.

According to a preferred embodiment, the method comprises the following step:
e. investing funds in accordance with the selected portfolio weights.

The invention further relates to a non-transitory computer-readable medium for selecting a value of portfolio weight for each of a plurality of assets of a portfolio, each asset having a defined expected return and a defined standard deviation of return, each asset having a covariance with respect to each of every other asset of the plurality of assets, the non-transitory computer-readable medium comprising instructions stored thereon, that when executed on a processor, perform the steps of:
a. creating a mean-risk portfolio optimization model/problem to compute the mean-risk efficient frontier based at least on input data characterizing the defined expected return and the defined standard deviation of return of each of the plurality of assets;
b. adding a diversification function to the mean-risk portfolio optimization model/problem;
c. computing the diversified efficient frontier; and
d. selecting a portfolio weight for each asset from the diversified efficient frontier.

According to a preferred embodiment, the non-transitory computer-readable medium comprises instructions stored thereon, that when executed on a processor, perform the step of:
e. investing funds in accordance with the selected portfolio weights.

The invention also relates to a computer program product for use on a computer system for selecting a value of portfolio weight for each of a specified plurality of assets of a portfolio and for enabling investment of funds in the specified plurality of assets, each asset having a defined expected return and a defined standard deviation of return, each asset having a covariance with respect to each of every other asset of the plurality of assets, the computer program product comprising a computer usable medium having computer readable program code thereon, the computer readable program code including:
a. program code for causing a computer to perform the step of computing a diversified efficient frontier;
b. program code for causing the computer to select a portfolio weight for each asset from the diversified efficient frontier for enabling an investor to invest funds in accordance with the selected portfolio weight of each asset.

Therefore, the invention provides a method for evaluating an existing or putative portfolio having a plurality of assets. The mean-risk efficiency from the classical portfolio optimization according to Markowitz is extended to a mean-risk-diversification efficiency avoiding the well-known practical problems of low diversified portfolios that arise from the classical mean-risk optimization. The new investment target diversification is established next to the classical investment targets return and risk. The inclusion of a diversification target is provided by diversification functions which are also part of the invention. By adding an explicit diversification target into a portfolio optimization the following advantages are achieved:

Beside the return- and risk input data an additional opportunity to transfer market views into a portfolio optimization model is given. The diversification of a portfolio can be measured and make different portfolios comparable with regard to diversification and not only with regard to return or risk. It is possible to determine a minimal diversification level that should be reached when portfolios are optimized. A broad diversified portfolio protects from great losses caused by extreme market developments.

### BRIEF DESCRIPTION OF THE DRAWINGS

FIG. 1 displays a (mean-risk) efficient frontier according to Markowitz;

FIG. 2 displays a diversification set;

FIG. 3 displays a diversification function;

FIG. 4 displays the extended (return-risk-diversification) efficient frontier—the diversified efficient frontier;

FIG. 5 displays the extended (return-risk-diversification) efficient frontier from view A compare FIG. 4—the diversified efficient frontier; and

FIG. 6 displays portfolios with the same portfolio risk level and different choices of gamma.

### DETAILED DESCRIPTION OF PREFERRED EMBODIMENTS

It is a well-known fact, that the classical portfolio optimization model (CPOM) (compare e.g. the exemplary formulation (3)) according to Markowitz or its extensions (compare e.g. the exemplary formulation (4)) leads to low diversified portfolios. This hampers the practical application of the model (Black/Littermann, Michaud, Green/Hollifield). Low diversified portfolios increases investor's risk in extreme market situations—while in a broad diversified portfolio investment losses can be balanced out this is hardly possible in a portfolio concentrated on just a few investments. Risk measures used in the CPOM like the variance refer to possible deviations from the forecast return in average. In financial crises this deviation can increase dramatically up to a total loss of some investments.

This invention extends the usual risk and return investment target notation by a third investment target—the diversification. Therefore, the new notations diversification set, diversification function, diversification target, and diversified efficient frontier are established.

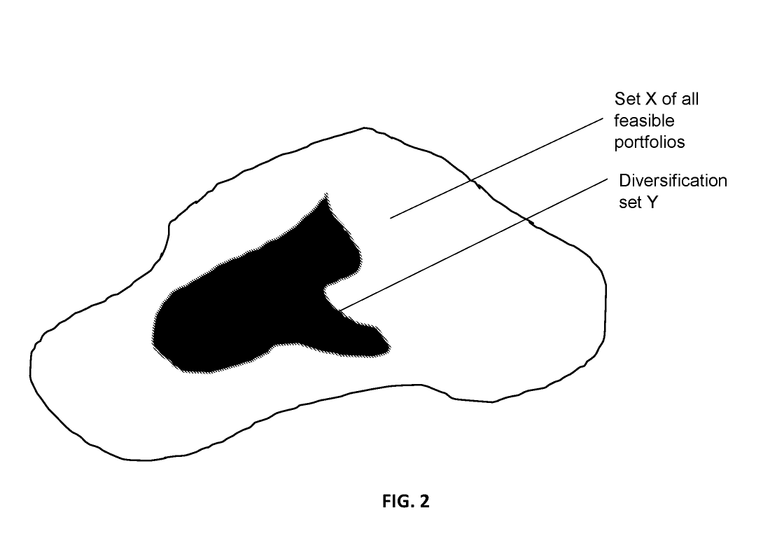

Diversification set: The diversification set is a non-empty subset of the set of all feasible portfolios illustrated in FIG. 2. The diversification set includes all portfolios that are approved to be well diversified.

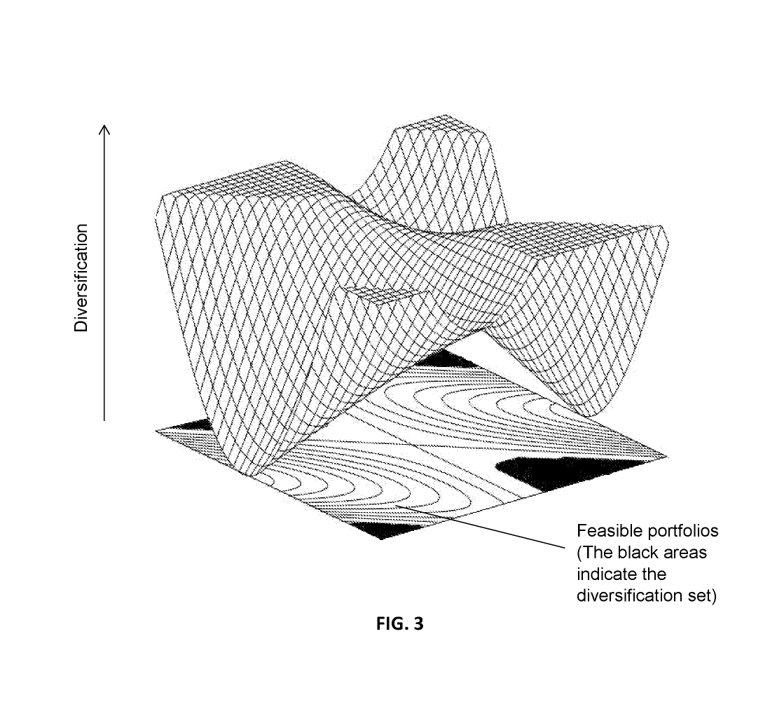

Diversification function: A diversification function is a function that assigned each portfolio its diversification degree and takes its maximal values for all portfolios that are included in the diversification set. In FIG. 3 a diversification function is illustrated for a given diversification set.

Diversification target: A diversification target is established in a portfolio optimization model when a diversification function extends a mean-risk portfolio optimization model.

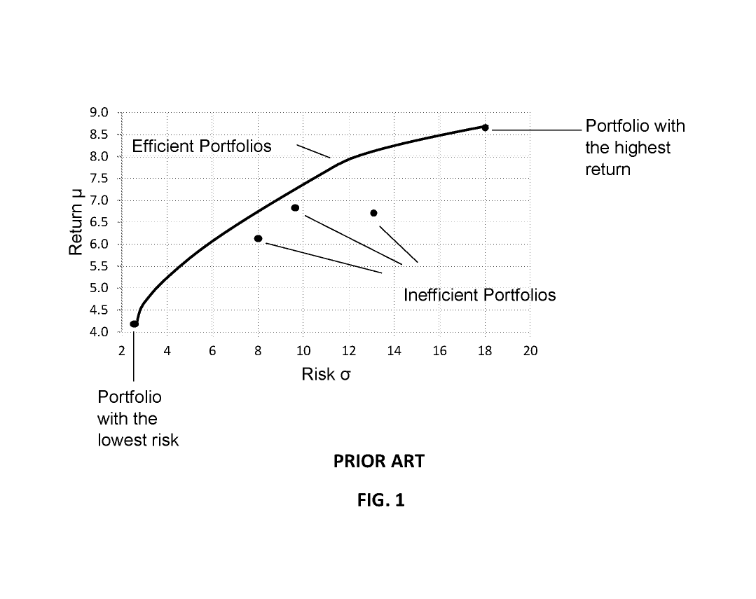

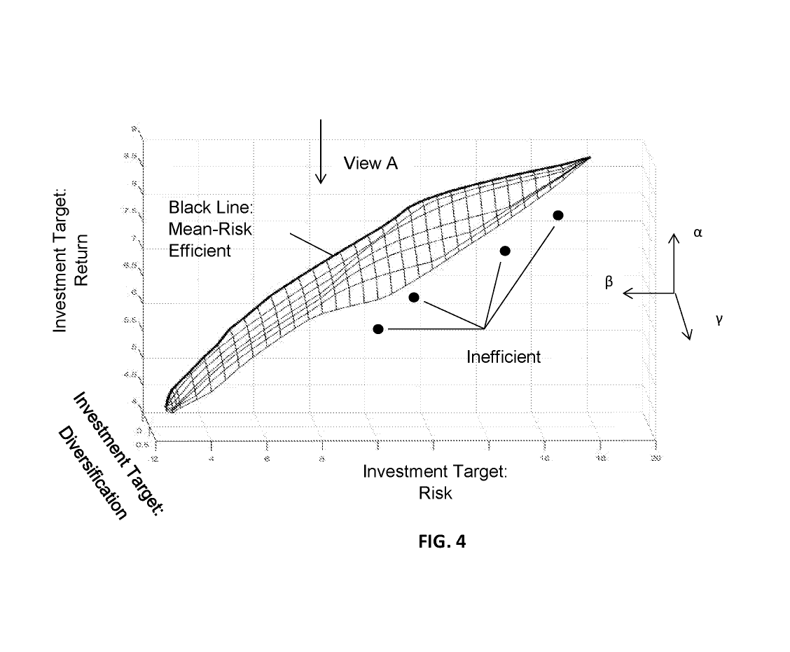

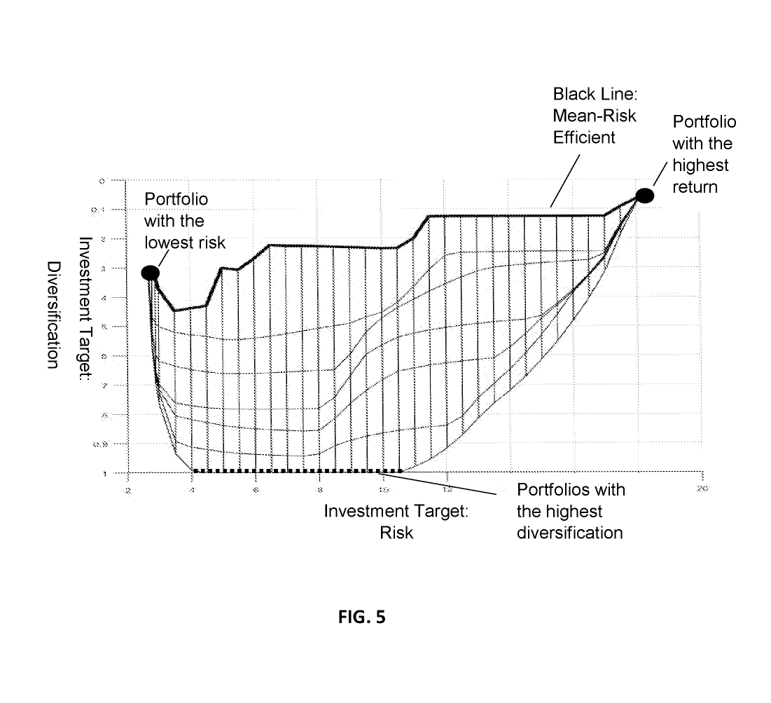

Diversified efficient frontier: As shown in FIG. 1, the efficient frontier is a line that indicates efficient portfolios in terms of return and risk. If a third investment target is added, the set of efficient portfolios indicates no longer a line but a surface. The efficient frontier of a portfolio optimization model that includes a return, a risk and a diversification target is called diversified efficient frontier, compare FIG. 4 and FIG. 5.

A more detailed description follows. The invention extends the CPOM by an additional investment target—the diversification target, next to the well-known investment targets return and risk. The exemplary formulation (4) can be extended by

max{αμ(w)−βv(w)+γδ(w)|w∈X} (5)

where δ is a diversification function that quantifies the diversification of a portfolio. To quantify the diversification the diversification function δ has to fulfil the following condition:

$${argmax}_{w ∈ X} δ ( w ) = Y \qquad ( 6 )$$

where Y is a diversification set described above. Condition (6) ensures that portfolios which are included in the diversification set have the highest diversification since these are the portfolios which are approved to be well-diversified by an investor. In other words, all portfolios that are not included in the diversification set have a lower diversification.

### EXAMPLE

Diversification target: The diversification target is to have at least a minimum investment volume in n possible investments that should be depended, for example on a scalar of the Sharpe Ratio sᵢ of each investment i=1, . . . , n (Sharpe).

Diversification set: Y={w ∈ X|wᵢ≥sᵢ, i=1, . . . , n}, where X is the set of all feasible portfolios, compare FIG. 2.

Diversification function:

$$δ ( w ) = 1 - \frac{1}{n - 1} {\sum }_{i = 1}^{n} {1}_{\{ {w}_{i} \geq {s}_{i} \}} {( \frac{{w}_{i} - {s}_{i}}{{s}_{i}} )}^{2}$$

Condition (6) holds. Beside this example there are a lot of other possible diversification targets, e.g. to have at most a maximum investment volume in n possible investments or to have a minimum number of investments in the portfolio. A diversification function can also be derived from a diversification measure introduced, for example, in Frahm/Wiechers. After a diversification target, a diversification set Y and a diversification function δ, fulfilling condition (6), have been determined in an arbitrary sequence, the diversification function is included in a mean-risk portfolio optimization problem, e.g. in the objective as shown in the exemplary formulation (5).

In case of example (5) the preference of the third investment target diversification can be controlled by the parameter γ≥0 analogous to the parameter α≥0 and β≥0 for the investment targets return and risk. By adding a third investment target the efficient frontier is extended to a three dimensional surface, compare FIG. 4 and FIG. 5. This efficient frontier is called diversified efficient frontier. Some portfolios that are not efficient in this sense are illustrated in FIG. 4. The black line indicates the origin efficient frontier according to Markowitz. In FIG. 5 the diversified efficient frontier is shown from direction A. The black line indicates again the origin efficient frontier according to Markowitz. The portfolio with the lowest risk and the portfolio with the highest return are illustrated, compare FIG. 1. In accordance with the additional investment target diversification, the portfolios with the highest diversification are also illustrated. These portfolios are portfolios included in the diversification set. All other portfolios of the diversified efficient frontier are efficient in a return-/risk and diversification compromise comparable with the return-/risk compromise in FIG. 1.

In FIG. 1 the efficient frontier of the COPM is illustrated. Efficiency is there defined in a return-/risk compromise: a portfolio is efficient if there is no other portfolio with a higher or equal return and a lower or equal risk with at least one investment target strictly higher or, respectively, strictly lower. The portfolios of that efficient frontier are in general low-diversified (Black/Littermann, Michaud, Green/Hollifield). To take influence explicitly on the diversification of computed portfolios we define diversification as third investment target next to return and risk. Efficiency is then defined in a return-/risk and diversification compromise: a portfolio is efficient if there is no other portfolio with a higher or equal return and a lower or equal risk and a higher or equal diversification with at least one investment target strictly higher or, respectively, strictly lower.

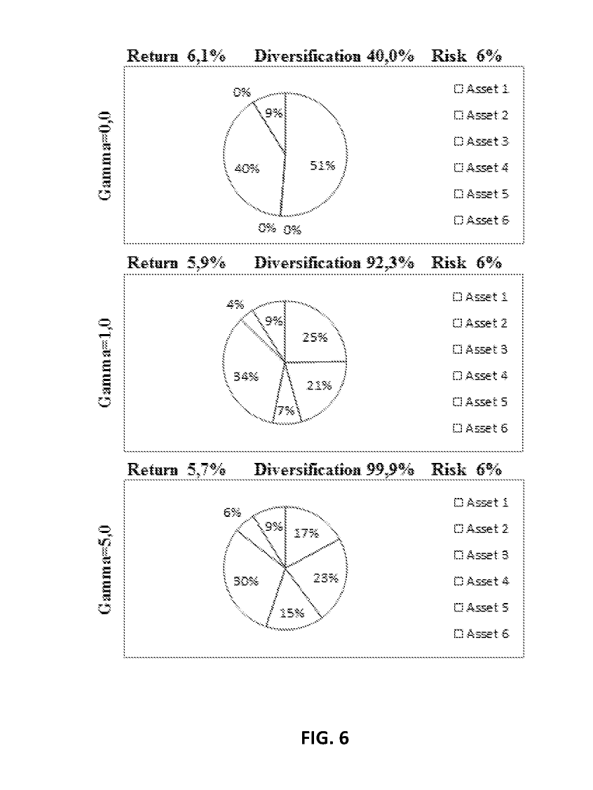

The invention provides an additional decision criterion. In FIG. 6 three portfolios of the diversified efficient frontier are shown with the same level of risk. It can be recognized that the higher the preference parameter for the investment target diversification γ is chosen, in case of applying example (5), the higher the portfolio diversification and the lower the expected return. Now, the opportunity to choose a level of portfolio diversification is given. In the CPOM one would get only the information about the first portfolio in FIG. 6. The invention derives more alternatives to avoid extreme portfolio structures that hamper the practical application of the CPOM as discussed in many publications (e.g. Black/Littermann, Michaud, Green/Hollifield).

In an alternative embodiment, the disclosed method for evaluating an existing or putative portfolio may be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

The described embodiments of the invention are intended to be merely exemplary and numerous variations and modifications will be apparent to those skilled in the art. All such variations and modifications are intended to be within the scope of the present invention as defined in the appended claims.

We claim:

1. A computer-implemented method for selecting a value of portfolio weight for each of a plurality of assets of a portfolio, each asset having a defined expected return and a defined standard deviation of return, each asset having a covariance with respect to each of every other asset of the plurality of assets, the method comprising the following steps:
a. creating a mean-risk portfolio optimization model/problem to compute the mean-risk efficient frontier based at least on input data characterizing the defined expected return and the defined standard deviation of return of each of the plurality of assets;
b. adding a diversification function to the mean-risk portfolio optimization model/problem;
c. computing the diversified efficient frontier; and
d. selecting a portfolio weight for each asset from the diversified efficient frontier.

2. The computer-implemented method according to claim 1 further comprising the following step:
e. investing funds in accordance with the selected portfolio weights.

3. A non-transitory computer-readable medium for selecting a value of portfolio weight for each of a plurality of assets of a portfolio, each asset having a defined expected return and a defined standard deviation of return, each asset having a covariance with respect to each of every other asset of the plurality of assets, the non-transitory computer-readable medium comprising instructions stored thereon, that when executed on a processor, perform the steps of:
a. creating a mean-risk portfolio optimization model/problem to compute the mean-risk efficient frontier based at least on input data characterizing the defined expected return and the defined standard deviation of return of each of the plurality of assets;
b. adding a diversification function to the mean-risk portfolio optimization model/problem;
c. computing the diversified efficient frontier; and
d. selecting a portfolio weight for each asset from the diversified efficient frontier.

4. The non-transitory computer-readable medium according to claim 3, comprising instructions stored thereon, that when executed on a processor, perform the step of:
e. investing funds in accordance with the selected portfolio weights.

5. A computer program product for use on a computer system for selecting a value of portfolio weight for each of a specified plurality of assets of a portfolio and for enabling investment of funds in the specified plurality of assets, each asset having a defined expected return and a defined standard deviation of return, each asset having a covariance with respect to each of every other asset of the plurality of assets, the computer program product comprising a computer usable medium having computer readable program code thereon, the computer readable program code including:
a. program code for causing a computer to perform the step of computing a diversified efficient frontier.
b. program code for causing the computer to select a portfolio weight for each asset from the diversified efficient frontier for enabling an investor to invest funds in accordance with the selected portfolio weight of each asset.

6. A method for investing funds based on evaluation of an existing portfolio having a plurality of assets, the existing portfolio having a total portfolio value, each asset having a value forming a fraction of the total portfolio value, each asset having a defined expected return and a defined standard deviation of return, each asset having a covariance with respect to each of every other asset of the plurality of assets, the method comprising:
a. creating a mean-risk portfolio optimization model/problem to compute the mean-risk efficient frontier based at least on input data characterizing the defined expected return and the defined standard deviation of return of each of the plurality of assets;
b. adding a diversification function to the mean-risk portfolio optimization model/problem;
c. computing the diversified efficient frontier; and
d. selecting a portfolio weight for each asset from the diversified efficient frontier.

7. The method according to claim 6 further comprising the following step:
e. investing funds in accordance with the selected portfolio weights.
